(19) United States
(12) Patent Application Publication
(10) Pub. No.: US 2011/0011227 A1
(43) Pub. Date: Jan. 20, 2011

(54) METHOD AND APPARATUS FOR NON-ROTARY HOLEMAKING BY MEANS OF CONTROLLED FRACTURING

(76) Inventors: William Q. Tingley, III, Grand Rapids, MI (US); William Q. Tingley, Grand Rapids, MI (US); Daniel R. Bradley, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/791,146

(22) Filed: Jun. 1, 2010

Related U.S. Application Data
(60) Provisional application No. 61/225,673, filed on Jul. 15, 2009.

(51) Int. Cl. B26D 3/00; B26D 5/08

(52) U.S. Cl. 83/39; 83/523

(57) ABSTRACT

A method and apparatus for producing a hole in any material by means of controlled fracturing using non-rotary machining includes the steps of fixturing a workpiece to the table of a non-rotary holemaking machine tool (103). The cutting tool is then fixtured to the column of the machine tool (105) and the face of the cutting tool is positioned perpendicular to the centerline of the proposed hole (107). The surface of the workpiece is approached with the cutting tool to a predetermined clearance level (109). Thereafter, the cutting tool is driven with sufficient force to induce instantaneous strain in the material of the workpiece to a depth necessary (111) to create a hole of a desired size and shape using a drive mechanism (113). The cutting tool is then repositioned so that the face of cutting tool is perpendicular to centerline of a subsequent hole to be produced (117).

### CLAIM OF PRIORITY TO RELATED APPLICATIONS

This application claims priority under 35 U.S.C. §120 to U.S. Provisional Application Ser. No. 61/225,673, entitled “METHOD FOR NON-ROTARY HOLEMAKING” filed Jul. 15, 2009, and assigned to Tennine Corporation.

### FIELD OF THE INVENTION

The present invention relates generally to holemaking and more specifically to holemaking by means of controlled fracturing vis-a-vis electrolysis, ablation, or plastic deformation using non-rotary machine tools.

### BACKGROUND OF THE INVENTION

The United States Air Force's Advanced Manufacturing Propulsion Initiative (AMPI) has identified limitations in current manufacturing technologies for machining cooling holes needed to maximize performance in advanced fighter aircraft turbine engines that generate thrust in the 25,000 pound class. Typical production methods for these holes are generally termed “small hole drilling”. The processes for making these holes use techniques such as Electrical Discharge Machining (EDM), laser cutting, and hard tool drilling and are used on various turbine engine components. Although these processes operate to produce holes, there are number of problems associated with these machining methods that do not work well for meeting the current design and manufacturing demands of advanced fighter turbine engines.

These problems include a low productivity using small hole drilling in view of the complex arrangements of thousands of cooling holes in a single part as well as the lack of automation that gives rise to an inadequate process control. This inadequate process control generally occurs in view of a reliance upon an intensive operator intervention that is used to drill “on the fly”. Problems can also be related to the lack of precision and repeatability in hole location and the absence of part-to-part compensation to avoid set-up difficulties in subsequent operations and mismatches with mating components. The inability to consistently and accurately measure hole features and the high cost, waste, and repeatability limitations for manufacturing small hole drilling electrodes for EDM can also be problematic. Further, heat generated by EDM, laser-cutting as well as the hard tool drilling that causes recasting of hole walls, micro-cracking, and de-lamination work to increase the risk of premature part failure. Severe limitations and inability of EDM, laser-cutting, and hard tool drilling to produce angled holes, non-round holes, and tapered or flared hole walls are also an issue in addition to the inability of EDM to machine non-metallic materials such as carbon fiber composites. When using these prior art processes, burrs, rough hole wall surfaces, and other finish defects inherent in hard tool drilling of metallic materials can occur as well as cracking, splitting, de-lamination, and other inherent defects in hard tool drilling of carbon fiber composite materials. Finally, laser-cutting produces a risk in burning part surfaces in the vicinity of the terminal end of a through-hole that is sometimes referred to as backwall strike damage.

Hence, the objective of AMPI is to identify a small hole drilling technology that overcomes many of these problems while funding development of a new process within a predetermined time period to Manufacturing Readiness Level 7—i.e., a proven manufacturing process ready for both low-rate initial production and full-rate production of turbine engine components having complex arrangements of thousands of cooling holes.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow chart diagram illustrating steps in accordance with an embodiment of the method of the invention.

FIG. 2 is a flow chart diagram illustrating the sub-steps used in the non-rotary hole making process shown in FIG. 1.

FIG. 3 is a perspective view of a non-rotary machining apparatus in accordance with the “3-axis” and “4-axis” embodiments of a non-rotary holemaking apparatus in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENT

Before describing in detail embodiments that are in accordance with the present invention, it should be observed that the embodiments reside primarily in combinations of method steps and apparatus components related to non-rotary holemaking by means of controlled fracturing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

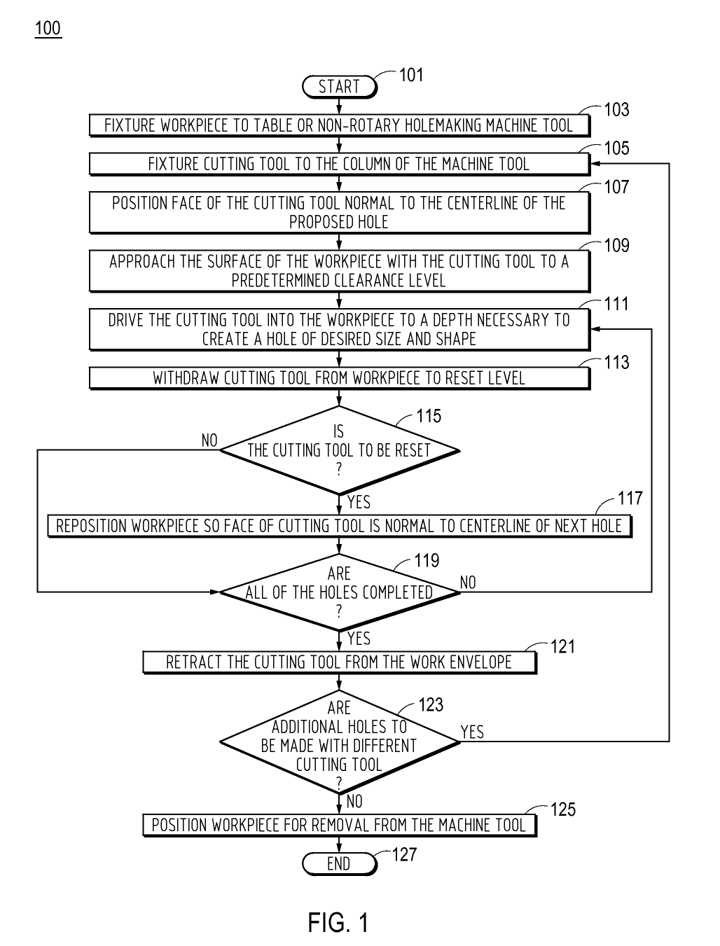

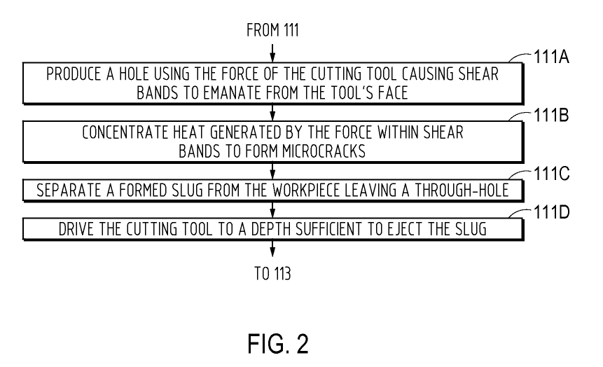

In accordance with an embodiment of the invention, FIG. 1 illustrates a method of non-rotary holemaking 100 that employs controlled fracturing as compared with plastic deformation of metallic, carbon fiber composite, and other materials to rapidly and precisely produce small holes within a wide range of shapes. As described in U.S. application Ser. No. 12/520,785, filed Jun. 22, 2009, entitled “METHOD AND APPARATUS FOR NON-ROTARY MACHINING,” which claims priority to PCT Application Serial No. PCT/US2006/0602572, filed Dec. 22, 2006, now WIPO Publication No. WO2008/079151A1, and U.S. application Ser. No. 12/618,047, filed Nov. 13, 2009, entitled “METHOD AND APPARATUS FOR CONTROLLED-FRACTURE MACHINING”, all of which are herein incorporated by reference, teach the use of advanced methods of shaping and machining materials without the use of rotary-type machining processes. Similarly, FIG. 2 illustrates a sub-process 200 that occurs in the process of producing a non-rotary machined hole. The process begins 101 where a workpiece is fixtured to the table of the non-rotary holemaking machine tool 103. The cutting tool is fixtured to the column of the machine tool 105 that contains a motor or other mechanism for driving the tool into the workpiece. By a combination of linear and rotary motion (of either or both the table and column along linear and rotary axes conventional to computer numerical controlled machine tools), the workpiece is positioned so that the face of the cutting tool is positioned perpendicular to the centerline of a desired hole 107. In a substantially rapid motion, the cutting tool approaches and is positioned near the surface of the workpiece at a predetermined clearance level 109. An electromagnetic, pneumatic, or hydraulic drive mechanism located within the column operates to drive the cutting tool into the workpiece to a depth necessary so that a hole having the size and shape of the cutting tool's face is forced through the workpiece 111.

As illustrated in FIG. 2, the hole is produced by the force of the cutting tool driving into the workpiece sufficient to cause instantaneous strain in the material of the workpiece. Instantaneous strain occurs when a material's yield strength and breaking strength are exceeded simultaneously. Inducing instantaneous strain in the material of the workpiece by means of the method of this present invention causes shear bands to emanate along the perimeter of the cutting tool's face in a direction perpendicular to the face of the cutting tool 111A. Heat generated by this force is concentrated in the shear bands and forms cracks which become connected under continued pressure from the cutting tool 111B. Cracking within the shear bands separates a slug from the workpiece leaving a through-hole having the size and shape of the cutting tool's face 111C. The cutting tool drives to a depth sufficient to eject the slug from the workpiece 111D. This process of holemaking is called “controlled fracturing”.

Upon the face of the cutting tool reaching a predetermined hole depth, the column withdraws the cutting tool from the workpiece to a level sufficient to reset the cutting tool and re-position the workpiece, as necessary 113. This process is accomplished without the tool and the workpiece interfering with one another. Thereafter, a determination is made if the cutting tool is to be reset to produce another hole 115. If more holes are desired, the drive mechanism resets the cutting tool. By a combination of linear and rotary motion of either or both the table and column, the workpiece is re-positioned so that the face of the cutting tool is perpendicular to the centerline of the next hole 117.

Next, a determination is made if all the holes to be made are completed 119. If not, steps 111 to 119 are repeated as necessary. If more holes to be made by the non-rotary process require a different cutting tool, the column retracts the cutting tool from the work envelope 121. If additional holes are to be made with another cutting tool, steps 105 to 121 are repeated as necessary. Once a determination is made 123 that no further holes are needed with all variations of cutting tools using the non-rotary hole making process, the table positions the workpiece for removal from the machine tool 125. Thereafter, the process ends and is complete 127.

Those skilled in the art will recognize that controlled fracturing is superior to electrolysis, the material removal process employed by EDM, in terms of speed, precision, productivity, and applicability to non-metallic materials. Controlled fracturing is superior to ablation, the material removal process employed by laser cutting in terms of speed, precision, productivity, and the absence of burning and backwall strike damage. Controlled fracturing is superior to plastic deformation, the material removal process employed by hard tool drilling. Although both processes rupture the material of the workpiece to produce a hole, the instantaneous strain produced by the non-rotary motion of the cutting tool in controlled-fracture machining is the mechanical difference that mitigates and even eliminates the problems of plastic deformation. Because the strain on the material does not accumulate over an extended period of time but instead occurs instantaneously, the material is not torn from the workpiece, as is the case of plastic deformation caused by the rotation of a drill, but instead it is removed by fracturing along shear bands that are perpendicular to the face of the tool. Thus, a hole is rapidly produced in the size and shape of the tool face without the expansive heat of plastic deformation that arises as strain accumulates in the material. Additionally, the contour of the hole is clean and smooth without burrs or other defects since the fracturing force shears the hole instead of tearing material to produce the hole. Furthermore, varying the driving force of the tool may allow for controlled diffusion of the shear bands to produce both tapered and flared holes. For these reasons, controlled fracturing is superior to plastic deformation in terms of speed, precision, productivity, mitigation or elimination of burrs in metallic materials and delamination of carbon fiber composites, mitigation or elimination of cracking especially in carbon fiber composites, and production of non-round, tapered, and flared holes.

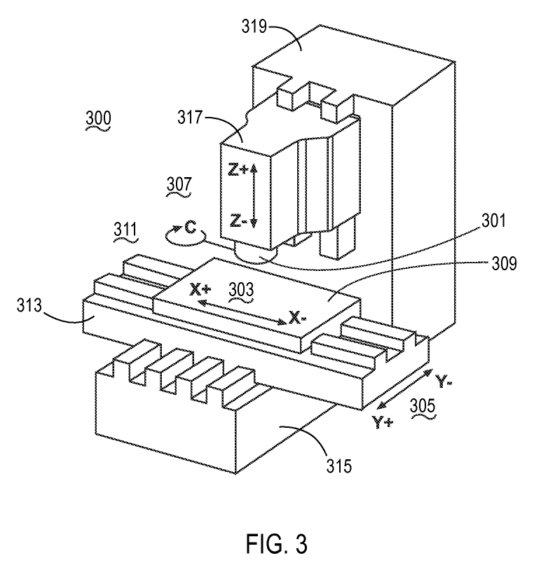

FIG. 3 is a perspective view of a non-rotary machining apparatus in accordance with the “3-axis” and “4-axis” embodiments of a non-rotary holemaking apparatus in accordance with the present invention. The apparatus employing the non-rotary methods of the present invention can be embodied in a variety of configurations. These embodiments are comparable to those of computer numerical controlled mills (known in the trade as “machining centers”), except that the present invention does not use a spindle to rotate a cutting tool. Instead, a non-rotary cutting tool moveable in a 3-dimensional work envelope is used in accordance with various non-rotary holemaking embodiments of the present invention. As seen in FIG. 3, a tool holder 301 is used to replace a spindle into which a non-rotating cutting tool (not shown) can be affixed. By way of example and not limitation, the machine tool may be configured as a ball-nosed end mill used for rotary milling. The tool will typically have the same shape as the hole to be made with the cutting tool's face fixed to a single direction to facilitate removal of material by means of controlled fracturing.

The simplest embodiment of the present invention is a “3-axis” machine 300, which can drive the cutting or “machine” tool along any one of the three linear axes 303, 305, 307, or any combination of them (under certain circumstances), that together define the machine's 3-dimensional work envelope. The machine tool can be driven using a force generated from at least one from the group of electromagnetic, pneumatic, or hydraulic components. The “3-axis” machine 300 uses a plurality of channeled surfaces 313, 315 and 317, 319 for moving a holemaking tool along an X, Y and Z axis, separately or simultaneously, to position the cutting face of the tool at the location specified to produce a hole having a predetermined size and shape in the workpiece (not shown).

Still yet another embodiment is a “4-axis” machine, which has all of the 3-axis linear motion of the “3-axis” machine in addition to a “rotary axis” 311 to allow the cutting face of the tool to be positioned at any angle relative to the surface of the workpiece to produce a hole. Thus, both the “3-axis” machine 300 and “4-axis” machine may use both linear and rotary axis that are both mechanically and/or electronically controlled. The mechanism for the rotary fourth axis can be either a rotary tool holder 301 to which the cutting tool is attached or a rotary table 309 to which a workpiece is attached. By providing rotation of the cutting tool and/or the rotary table 309, the “4-axis” machine embodiment is sufficient to produce a hole in a workpiece by means of controlled fracturing as described herein.

Thus, the method as illustrated in FIGS. 1 and 2 and the apparatus shown in FIG. 3 provide a precision holemaking process and apparatus that can be used without the distorting effects of heat that are produced by EDM, laser-cutting, or hard tool drilling processes. As seen in FIG. 3, an embodiment of the present method also operates using a machine tool configured similarly to a multi-axis machining center for milling to facilitate the ready integration of proven automation technologies.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The invention claimed is:

1. A method for producing a hole in any material by means of controlled fracturing using non-rotary machining comprising the steps of:
fixturing the workpiece to a table of a non-rotary holemaking machine tool;
fixturing the cutting tool to the column of the machine tool;
positioning the face of the cutting tool perpendicular to the centerline of the proposed hole;
approaching the surface of the workpiece with the cutting tool to a predetermined clearance level;
driving the cutting tool into the workpiece to a depth necessary to make a through-hole;
creating a hole of a desired size and shape using a drive mechanism;
withdrawing the cutting tool from the workpiece to a predetermined level;
resetting cutting tool using the drive mechanism;
repositioning the workpiece so the face of cutting tool is perpendicular to centerline of a subsequent hole; and
retracting the cutting tool from the work envelope upon completion of the holemaking process.

2. A method for producing a hole in any material by means of controlled fracturing using non-rotary machining as in claim 1, wherein the step of creating a hole further comprises the steps of:
using the force of the cutting tool to induce instantaneous strain in the material of the workpiece thus causing shear bands to emanate from the face of the cutting tool;
concentrating heat generated by the force within the shear bands to form connecting cracks;
separating a slug, in the form of the size and shape of the cutting tool's face, from the workpiece leaving a through-hole; and
driving the cutting tool to a depth sufficient to eject the slug.

3. A method for creating a hole in a material using a non-rotary machining process comprising the steps of:
fixturing a workpiece to a table of a non-rotary holemaking machine tool;
fixturing the cutting tool to the column of the machine tool;
positioning the face of the cutting tool perpendicular to the centerline of a proposed hole;
approaching the surface of the workpiece with the cutting tool to a predetermined clearance level;
determining a force needed to create the proposed hole of a desired size and shape at the predetermined clearance level;
driving the cutting tool into the workpiece using the force necessary such that the depth creates a hole through the workpiece;
withdrawing the cutting tool from the workpiece to a predetermined level;
resetting the cutting tool using the drive mechanism;
repositioning the workpiece so the face of cutting tool is perpendicular to centerline of a subsequent hole; and
retracting the cutting tool from the work envelope upon completion of the holemaking process.

4. A method for creating a hole as in claim 3, further comprising the steps of:
creating shear bands to emanate from the face of the cutting tool using the force of the cutting tool;
forming connecting cracks by concentrating heat generated by the force within the shear bands;
forming a slug in the workpiece at the position of the hole using the force of the cutting tool; and
ejecting the slug using the cutting tool.

5. A method for non-rotary holemaking comprising the steps of:
fixturing a workpiece to a table of a non-rotary holemaking machine tool;
fixturing the cutting tool to the column of the machine tool;
positioning the face of the cutting tool perpendicular to the centerline of a proposed hole;
approaching the surface of the workpiece with the cutting tool to a predetermined clearance level;
determining a force needed to create the proposed hole of a desired size and shape at the predetermined clearance level;
driving the cutting tool into the workpiece using the force necessary such that the depth creates a hole through the workpiece by creating shear bands to emanate from the face of the cutting tool using a driving force of the cutting tool;
forming a slug in the workpiece at the position of the hole using the force of the cutting tool; and
ejecting the slug using the cutting tool.

6. A method for non-rotary holemaking as in claim 5, further comprising the steps of:
withdrawing the cutting tool from the workpiece to a predetermined level;
resetting the cutting tool using the drive mechanism;
repositioning the workpiece so the face of the cutting tool is perpendicular to centerline of a subsequent hole; and
retracting the cutting tool from the work envelope upon completion of the holemaking process.

7. An apparatus for producing a hole in a workpiece by means of controlled fracturing using a non-rotary machining process, comprising:
a moveable column;
a machine tool attached to the column for positioning the tool relative to the workpiece using a combination of linear and rotary motions along both linear and rotary axes; and
wherein the machine tool is driven with sufficient force in a substantially linear motion to induce an instantaneous strain in a workpiece for shearing a fractured hole having a predetermined shape.

8. An apparatus for producing a hole in a workpiece as in claim 7, wherein the machine tool is moveable in a 3-dimensional work envelope.

9. An apparatus for producing a hole in a workpiece as in claim 7, wherein the machine tool is configured as a ball-nosed end mill used for rotary milling.

10. An apparatus for producing a hole in a workpiece as in claim 7, wherein the linear and rotary axis are both mechanically and electronically controlled.

11. An apparatus for producing a hole in a workpiece as in claim 7, wherein the machine tool is driven using a force generated from at least one from the group of electromagnetic, pneumatic, or hydraulic components.

12. An apparatus for producing a hole in a workpiece as in claim 7, wherein the workpiece is a non-metallic carbon fiber composite material.
